(19) United States
(12) Patent Application Publication
(10) Pub. No.: US 2018/0341902 A1
(43) Pub. Date: Nov. 29, 2018

(54) Agency Based New Sales Opportunity Software System

(71) Applicant: Dark Capital Inc., Spokane, WA (US)

(72) Inventor: Sam Fleming, Spokane, WA (US)

(73) Assignee: Dark Capital Inc., Spokane, WA (US)

(21) Appl. No.: 15/983,971

(22) Filed: May 18, 2018

Related U.S. Application Data
(60) Provisional application No. 62/511,623, filed on May 26, 2017.

(51) Int. Cl. G06Q 10/06

(52) U.S. Cl. CPC G06Q 10/063116; G06Q 40/08

(57) ABSTRACT

A new time sensitive sales opportunity delivery and routing system is described. Sales opportunities are delivered to a network of sellers and agencies via a sales delivery system. The new sales opportunities are delivered to one or more sellers wherein a first timer is started. If a new sales opportunity sits for a first amount of time without a seller claiming it, it is rerouted to a second set of sellers. When a seller claims, or grabs an opportunity, a second timer starts. If the seller does not take action against the opportunity within a second amount of time, the opportunity is rerouted to a new group of one or more sellers.

### CROSS REFERENCE TO RELATED APPLICATION

This application claims the benefit of pending U.S. provisional application Ser. No. 62/511,623 filed May 26, 2017 by the present inventor, which is incorporated by reference in its entirety.

### STATEMENT REGARDING FEDERALLY SPONSORED R&D

Not related to this application.

### TECHNICAL FIELD

This invention relates to sales opportunity management for agency based sales models, and more particularly to the optimized identification and routing of opportunities in an electronic sales system.

### BACKGROUND OF THE INVENTION

Agency based sales models are common in the art of selling insurance and financial services. Agency sales models are also applicable to franchised businesses wherein a corporation may work in partnership with independently owned and operated regional offices. Unlike most businesses where the performance of all employees can be directed, success in agency based models requires influence and motivation to drive behaviors aligned with the corporation.

Sales opportunities, or leads, are important to all sales models. In the art of insurance and financial services, wherein agents sell to many people, leads and opportunities are paramount to growing revenues and generating profits. A corporation may spend many millions of dollars in advertising to drive customer interest and sales opportunities. Opportunities are generated through corporate websites, purchased leads from third party websites, and data mining business and consumer data. A single sales lead may cost over one hundred dollars of marketing investment, or cost tens of dollars or more to purchase. Sales opportunities vary in price depending upon conversion rates.

A particular challenge in today's electronic world of sales leads and opportunities is that consumer interest may be identified by numerous corporations at the same time. For example, a consumer may fill out an insurance form on a third party website, and that lead is sold and routed to numerous different corporations. It is has been found that the first person to make direct contact with the consumer has a higher probability to win the sale than other sellers that may wait minutes, hours or days to take action. It is desirable to route the sales opportunity to a seller in the right geography and has a high probability of making a personal connection with the prospect.

With corporations generating hundreds of thousands of sales opportunities each day, computer systems have been adopted for the routing of the sales opportunities to the optimal seller. An example sales computer system is described by U.S. Pat. No. 7,546,243 to Kapadia et al. Although useful for routing sales opportunities to sellers, or producers, it does not teach of ways to motivate sellers to take immediate action. Prior art electronic sales opportunity systems are directed at quickly filtering, scoring, and routing of leads. Again, although useful for evaluating and appropriately routing sales opportunities, they do not address seller urgency which is a significant factor in maximizing return on investment of marketing spend. Creating urgency for sellers to immediately take action on time sensitive sales opportunities is over looked or just assumed to be present. In today's systems, sellers may accept a new sales opportunity and then not take immediate action. In an agency based sales model, corporations may remedy the situation by utilizing a call center and essentially selling directly to consumers which can put pressure on the relationships between agencies and the corporation.

### BRIEF DESCRIPTION OF THE DRAWINGS

Preferred embodiments of the invention are described below with the reference to the following accompanying drawings:

FIG. 1 is a diagram showing the connections between a carrier, and multiple agencies and producers within an agency based sales model. FIG. 1 represents a captive carrier sales model.

FIG. 2 shows a diagram showing the connections between two or more competing carriers, and multiple agencies and producers. FIG. 2 represents an independent insurance sales model.

FIG. 3 is a flow diagram showing data flow between a prospect, a source of a sales opportunity, an opportunity management system, a carrier and a producer within an agency.

FIG. 4 is a diagram showing the opportunity management system of FIG. 3 and showing in more detail the flow of information to and from a producer within an agency.

FIG. 5 is a diagram showing an example high level data structure of how a sales opportunity for a prospect is transformed into content ready for delivery to one or more producers within one or more agencies.

FIG. 6 is a flow diagram showing the timing control of a sales opportunity within the opportunity management system.

FIG. 7 is a front view of a preferred embodiment user interface for a producer within the opportunity management system.

FIG. 8 is close up view of the new opportunity alert section of the view of FIG. 7

FIG. 9 is a front view of an opportunity screen for a producer to engage with a prospect on a new sales opportunity.

FIG. 10 is a diagram showing a new sales opportunity only on the screen of a single producer within a single agency. The producer with the exclusive view of the new opportunity is indicated by the dashed line.

FIG. 11 is a diagram showing a new sales opportunity only on the screens of producers within a single agency. The producers with the exclusive view of the opportunity is indicated by the dashed lines.

FIG. 12 is a diagram showing a new sales opportunity only on the screens of producers within a predetermined set of agencies. The producers with the exclusive view of the new sales opportunity is indicated by the dashed lines.

FIG. 13 is a diagram showing a new sales opportunity only on the screens of producers within a predetermined set of an alternative group. The producers with the exclusive view of the new sales opportunity is indicated by the dashed lines.

### SUMMARY OF THE INVENTION

The present invention takes a very different approach to delivering and routing of sales opportunities as part of a computerized sales system for an agency based sales model.

A source acquires information about a prospect interested in purchasing a product or service. The source delivers information about the prospect to a computer software system. The computer software system compares the information about the prospect to data within a database. A processor running an amount of computer code (logic) routes the prospect's information to one or more preferred sellers. A create date, or reference time, is created for the sales opportunity. Upon the prospect's sales opportunity being received by the one or more sellers, a first timer counts the elapsed time prior to a seller claiming, or “grabbing” the new opportunity. A first grab rule instructs the computer system to reroute the new sales opportunity to a new group of sellers if the opportunity is not grabbed within a grab timing rule. Upon grabbing by a particular seller, a second timer start. If the seller that grabbed the opportunity does not take action within an action timing rule duration, the computer software system applies a reroute rule to deliver the sales opportunity to a new group of sellers and removed it from the prior group. Data between the source, sellers and corporations “carriers” is shared over a network and processed by a processor “computer”, database and amount of code.

An object of the present invention is to quickly deliver a new sales opportunity to one or more matching sellers and have one of the sellers quickly make contact with the sales prospect.

An object of the present invention is to encourage an agency, within an agency based sales model, to quickly respond to a new sales opportunities generated by one or more carriers, or companies.

An object of the present invention is to deliver performance data of producers and sellers back to corporations on new sales opportunities.

An object of the present invention is to provide incentive to sellers to rapidly respond to new sales opportunities.

An object of the present invention is for the computer software system to deliver an amount of content to the producer to provide visual information regarding timing rules.

These and other features, aspects, and advantages of the present invention will become better understood with regard to the following description, appended claims, and accompanying drawings.

### DETAILED DESCRIPTION OF THE PREFERRED EMBODIMENTS

Some of the general components utilized in this invention are widely known and used in the field of the invention, and their exact nature or type is not necessary for a person of ordinary skill in the art or science to understand the invention; therefore they will not be discussed in detail. It is appreciated that components of networks, network transmission, the internet, databases and SaaS software are well known in the art of software and thus the exact features of computing systems and data transmission used are not needed for one to understand and practice the invention without undue experimentation, and thus will not be described in detail.

The present invention is directed at the delivery of new opportunities to sell insurance policies, or financial products, to prospective customers. Although the best mode is described as such, the present invention should not be construed to be limited to only insurance sales models. The present invention is applicable to other agency based sales models, including franchises.

As used herein, the term “carrier” is used to indicate a company, or corporation, that issues an insurance policy to a customer.

As used herein, the term “producer” is used to describe someone that sells something, such as an insurance policy to a customer.

As used herein, the term “agency” is used to describe a business comprised of one or more producers that has a business relationship with one or more carriers. The producers may be located within a single building or distributed geographically.

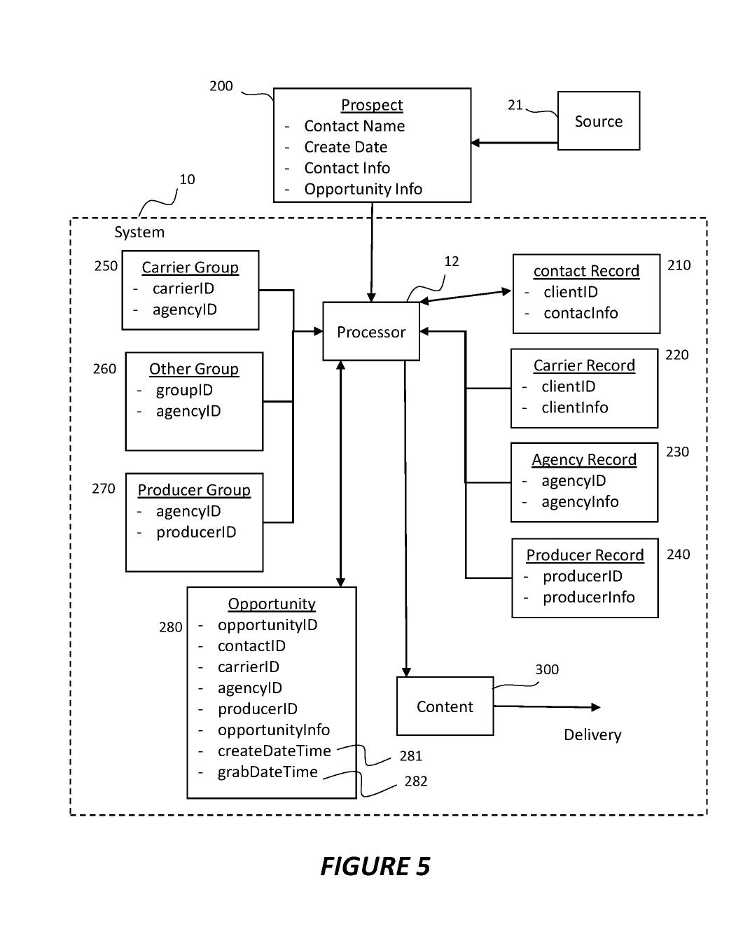

As used herein, the term “record” is used to describe a discrete amount of information within an information storage system. It is common in the art of software to store information within databases and arrays. It should be appreciated that the present invention may be accomplished with many different database architectures and system designs. The best mode of FIG. 5 is provided, but the present invention should not be construed to be limited to any particular structure of records. Data and records may be stored in physical devices such as hard drives or stored in an amount of computer memory.

In the art of insurance sales, it is common for a prospective customer to provide information to a computer system with the goal of receiving back one or more quotes from insurance carriers. Web sites exist that sell new sales opportunities directly to carriers, agencies and producers. Opportunities are most often routed to agencies based upon relationships between the prospect and an agency, such as geographical proximity and support for desired policy types. New sales opportunities are sent to an agency for producers to attempt to convert into a sale. Historically, the priority of new sales opportunities “leads” are determined by the producers, wherein some producers choose to work a new opportunity immediately and some may wait hours, days or more.

It has been found that with the short attention spans of today's consumers that a high priority and quick response by a producer to a new electronic sales opportunity can dramatically increase the probability of a new policy sales win. The present invention is directed at providing new sales opportunities to producers in a way that provide time controls and also provides incentive for producers to give high priority to new sales opportunities. As more sales opportunities continue to generate directly from carrier websites, there is a need for them to ensure the opportunities are acted upon in a way that matches the carrier's desired practices.

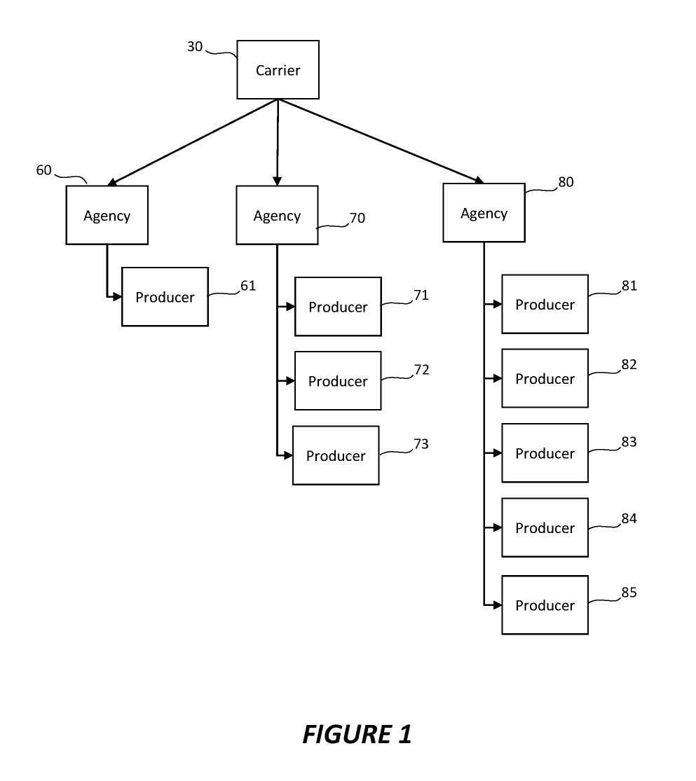

Most insurance carriers do not exclusively sell policies directly to consumers. The majority of insurance sales are made through agencies that operate independently of the carriers they represent. FIG. 1 shows the typical “exclusive” or “captive” carrier sales model wherein a captive carrier 30 sells through agencies that only sell products from carrier 30. Agencies may adapt to the regions they operate in and can vary in approach and the number of producers they employee. A single agency 60 has a single producer 61. A small agency 70 may have a producer 71, 72 and 73. A larger agency 80 may have a producer 81, 82, 83, 84, and 85. It should be appreciated that agencies 60, 70 and 80 are used to explain the present invention, and that actual carrier-agency networks are complex. It is not unusual for carrier 30 to have ten thousand agencies, each comprised of one or more producers.

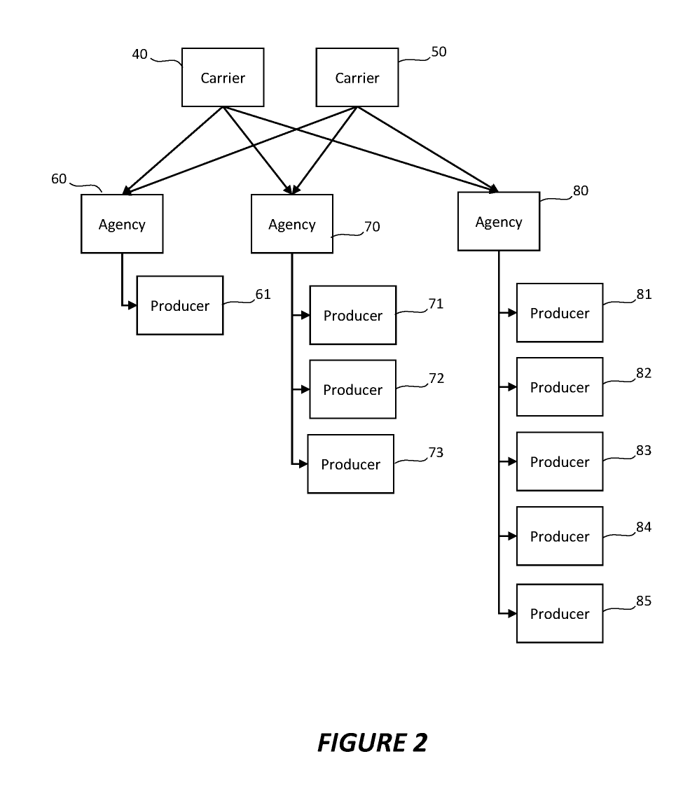

FIG. 2 shows an independent insurance sales model wherein a first independent carrier 40 and a second independent carrier 50 sell through common agencies. Again, agencies 60, 70 and 80 are separate legal entities. Unlike the captive model wherein the agencies only sell the products of a single carrier, in the independent agency model the agencies sell the products of multiple carriers. It should be appreciated that competition between carriers and agencies is high in the independent model.

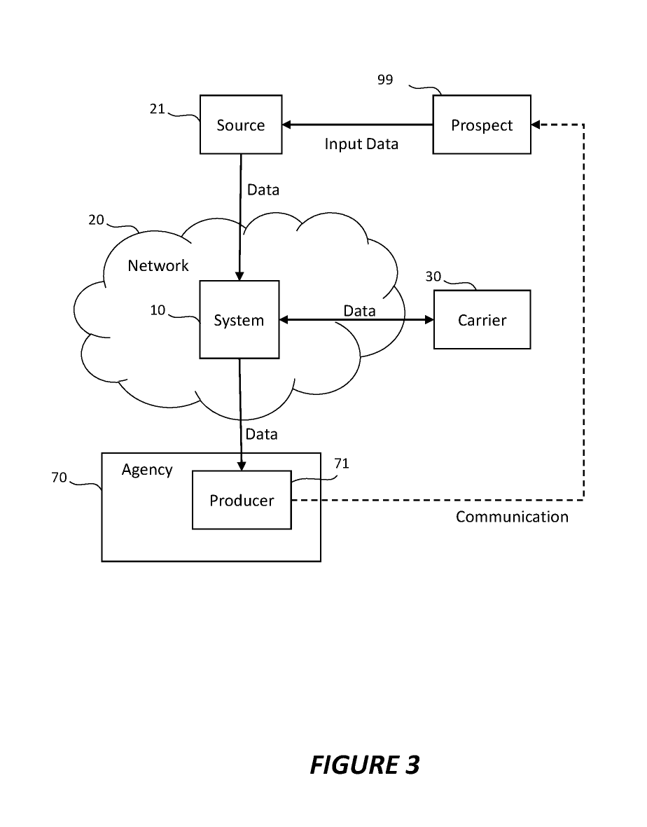

FIG. 3 shows the overall data flow between a prospect 99 that has interest in purchasing an insurance policy and a producer 71 that wants to sell insurance to prospect 99. Typically, prospect 99 provides their personal information to a source 21. Source 21 may be, but is not limited to an internet site that sells leads, a website of a carrier, a kiosk, or a mobile app. As an example, source 21 delivers prospect and opportunity data to a sales opportunity system 10. System 10 delivers data to producer 71 within agency 70. Depending upon the location of system 10, opportunity data and metrics may be provided to carrier 30 through a network 20. Ultimately, producer 71 makes communication with prospect 99 via common methods such as but not limited to e-mail, phone, SMS and video. It should be appreciated that network 20, such as but not limited to the internet, is used to connect source 21, system 10, carrier 30, producer 71 and prospect 99.

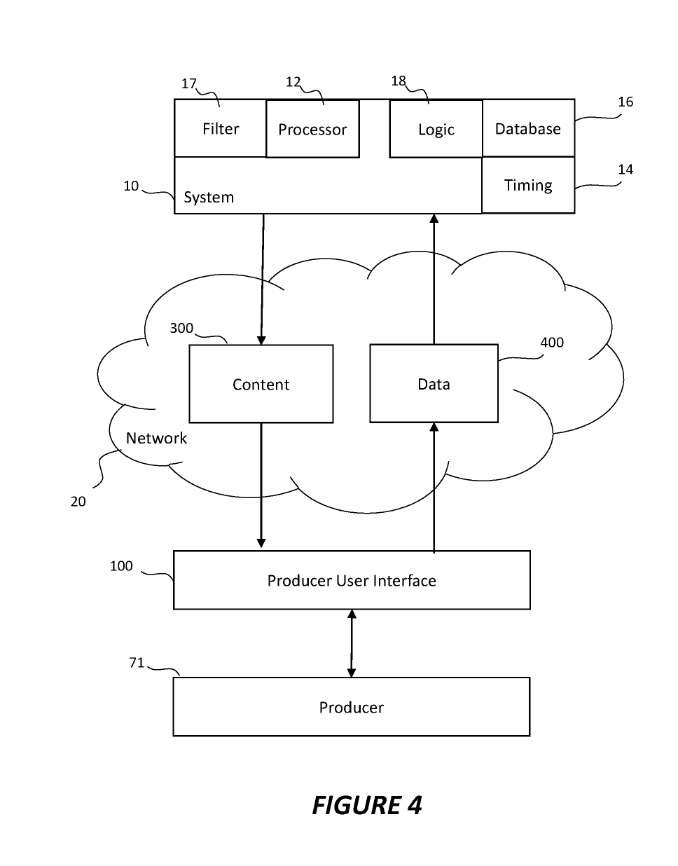

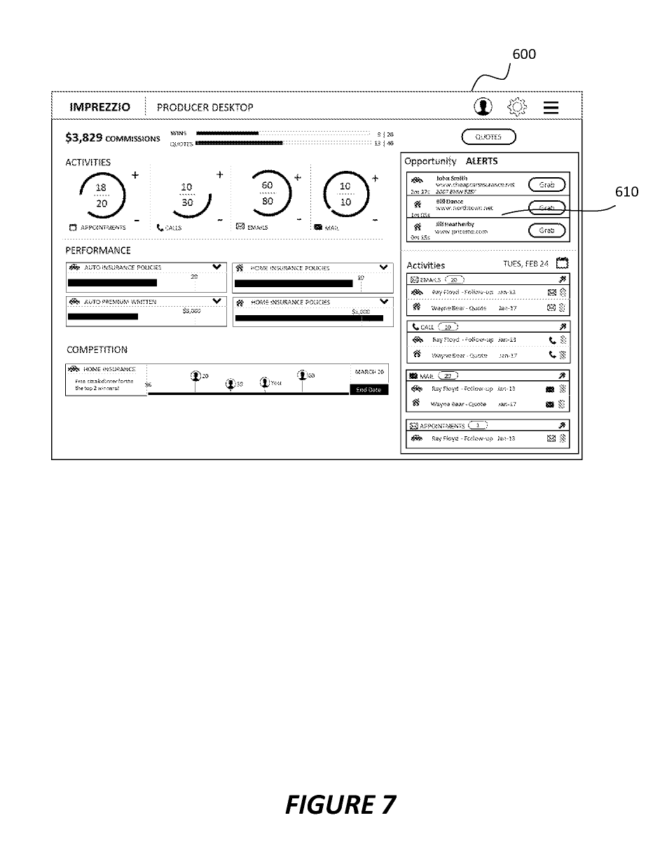

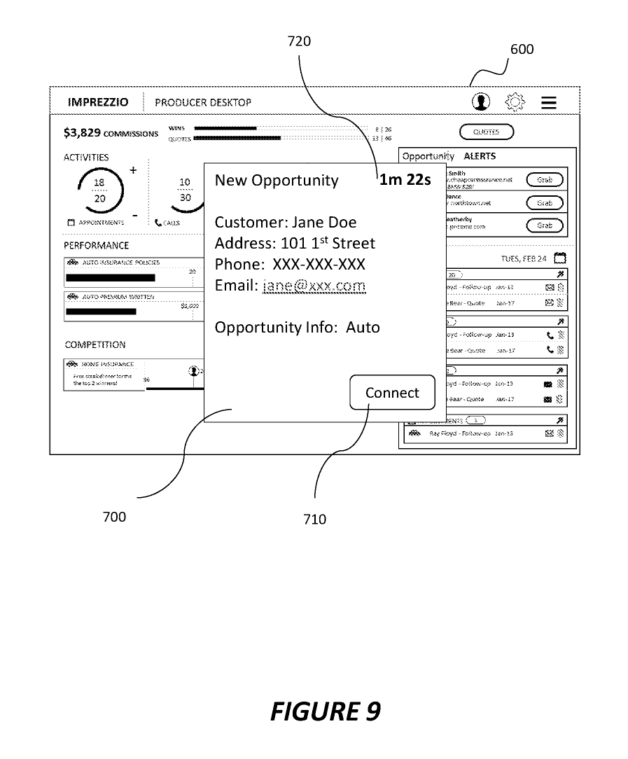

As shown in FIG. 4, system 10 is comprised of functions that may include but are not limited to a filter 17, a processor 12, a set of logic code 18, a database 16 and a timer 14. System 10 delivers an amount of content 300 to a producer user interface 100. Content 300 may be in the common HTML format or data for use within a mobile app. As previously described, content 300 is delivered over network 20. Content 300 creates an opportunity alert 610 that indicates a new opportunity is available to producer 71. Producer user interface 100 may include the screens shown in FIGS. 7, 8 and 9, or may be an SMS, e-mail or a phone call. Producer 71 may engage with user interface 100 and deliver an amount of return data 400 back to system 10.

As shown in FIG. 5, the input to system 10 is a prospect record 200, which is generated by source 21. Prospect record 200 contains text describing the name of the person interested and their contact information, as well as details on the opportunity to sell them one or more policies. In addition, prospect record 200 may contain a timestamp of when source 21 created prospect record 200 which creates a reference point to measure producer performance. Prospect record 200 preferably frames text and information within a scheme such as XML or JSON that can be consumed through an API by system 10.

Within system 10 is filter 17 which compares text field values of the data contained in an incoming prospect record 200 against known other values that may be stored in database 16 or within logic code 18. Such rules may include identifying profanity, false names such as “the Dude Lebowski” and other criterion that will indicate that prospect record 200 is of low quality or junk. Filter 17 may also compare the text in prospect record 200 against a contact record 210 of database 16 to identify past and current customers. In the event that filter 17 identifies that prospect 99 is a current customer, logic code 18 may assign an opportunity 280 to the producer of a producer record 240 or to an agency contained in an agency record 230. Both producer record 240 and agency record 230 are contained in database 16. If prospect record 200 does not contain a name or contact information associated with a name or contact information within database 16, processor 12 creates a new contact record 210 for prospect 99.

Also within database 16 are carrier group records 250 which tell processor 12 which agencies can represent certain carriers. A producer group record 270 tells processor 12 which producers are assigned to which agencies. The above is done with well-known hierarchy type models common in the art of databases and software. As needed to supply the right data to user interface 100, processor 12 may pull data from tables including a carrier record 220, agency record 230, producer record 240 utilizing common association methods such as IDs and keys. Processor 12 may also pull data from external data sources such as consumer data and credit scores sources through an API. With the desired information ready, processor 12 creates an opportunity 280 within database 16 and adds visual code, such as HTML, to create content 300 to be delivered to an agency or producer. It should be appreciated that opportunity 280 can contain a unique agency identifier (agencyID), a unique producer identifier (producerID), or both, and can be routed to the right destination using an optimal method (SMS, email, phone, web, app etc). With time being important in the response, processor 12 adds a “createDateTime” field 281 to opportunity 280, recording the time opportunity 280 is created, or the create date of prospect record 200, if it is available.

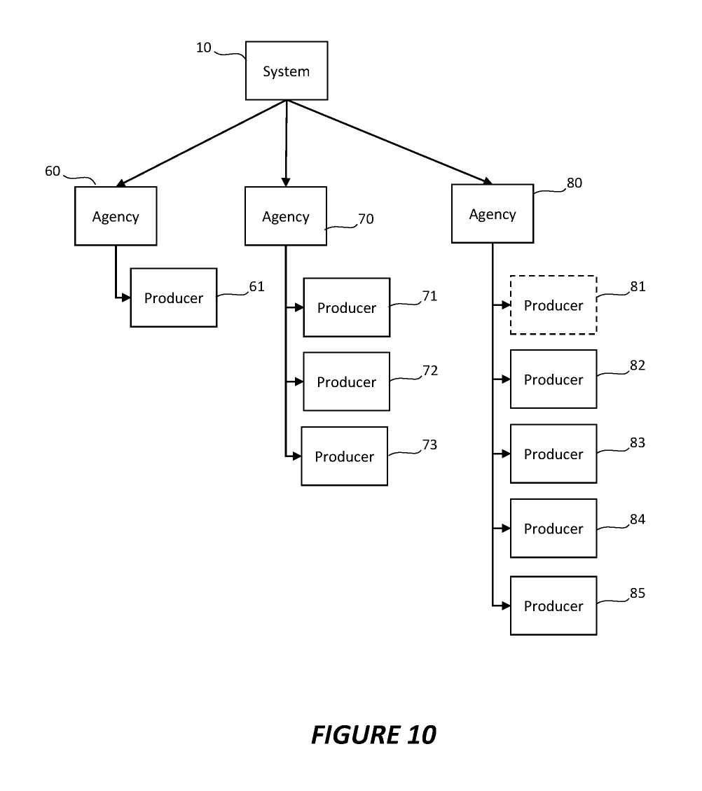

FIGS. 10, 11 and 12 show different delivery scenarios of opportunity 280 by system 10. Producers in a dashed line indicate that they received opportunity 280 and those in solid boxes have/will not.

In FIG. 10, opportunity 280 is routed directly to producer 81 and is not available by any other producers in system 10. In this scenario, producer 81 may be ideally suited for opportunity 280 or may have purchased an opportunity/lead for only their own consumption. System 10 uses the producer information or producerID associated to opportunity 280 to route it to producer 81.

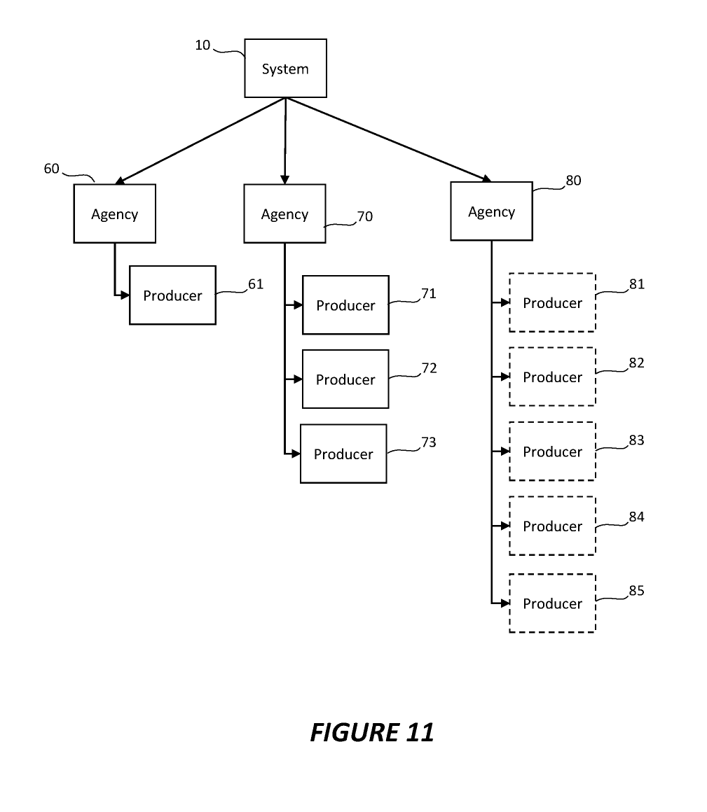

In FIG. 11, opportunity 280 is routed to all the producers within agency 80. Opportunity 280 shows up on the user interface 100 of producer 81-85. This delivery methodology may occur when an agency purchases leads, or agency 80 is ideally suited to work opportunity 280. In this scenario, system 10 uses the agency information or agencyID associated to opportunity 280, and routes opportunity 280 to all producers associated with agency 80. The goal of sending opportunity 280 to all producers is to get the best response time possible. When one producer “grabs” opportunity 280, data 400 is sent back to system 10 instructing it to populate the producerID of opportunity 280 and to also populate a “grabDateTime” 282 of opportunity 280 so it can be referenced. When one producer “grabs” opportunity 280, system 10 no longer allows another producer to “grab” the lead and work it.

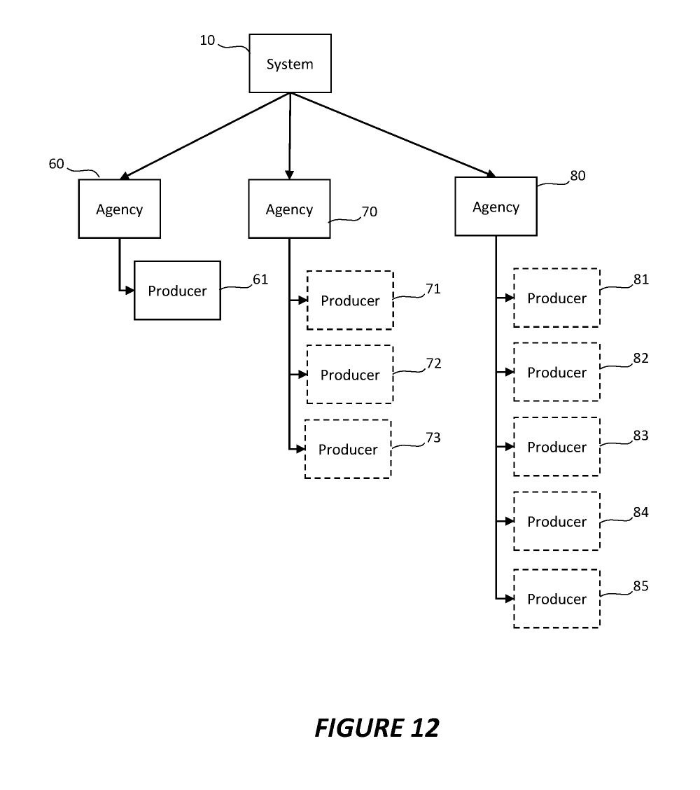

FIG. 12 shows yet another method of delivering opportunity 280.

In this case, opportunity 280 is sent to multiple agencies based upon an agency belonging to a desired other group 260. Other group 260 may be, but is not limited to a geographical region, a language spoken, or expertise on a certain type of policies. Similar to the example of FIG. 12, all producers 71-73 and 81-85 receive new opportunity 280 on their respective user interface 100 and may “grab” opportunity 280 to work. Through system 10, when one producer “grabs” opportunity 280, it is recorded and the opportunity is no longer available to other producers.

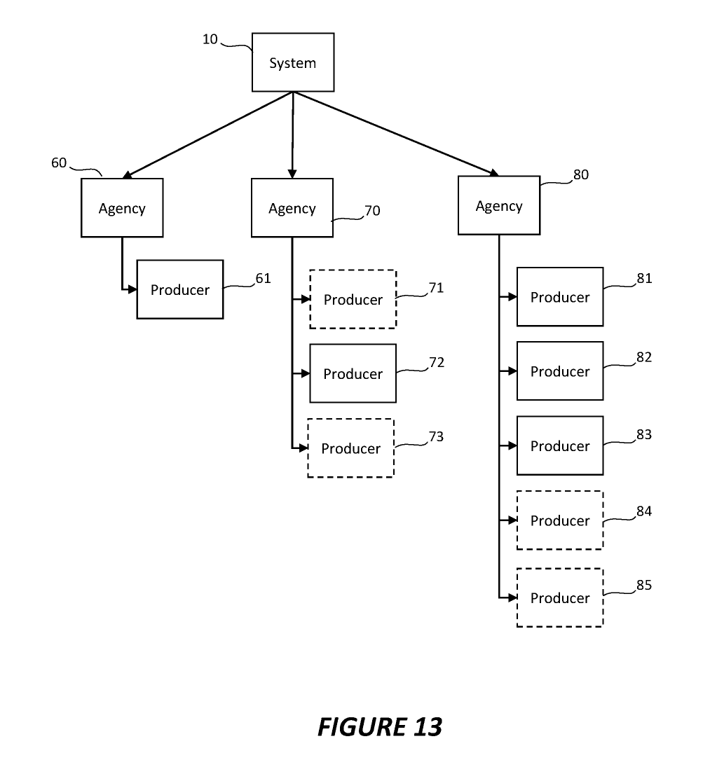

FIG. 13 shows yet another example wherein it may be desirable to make opportunity 280 available to a subset of producers within a plurality of agencies.

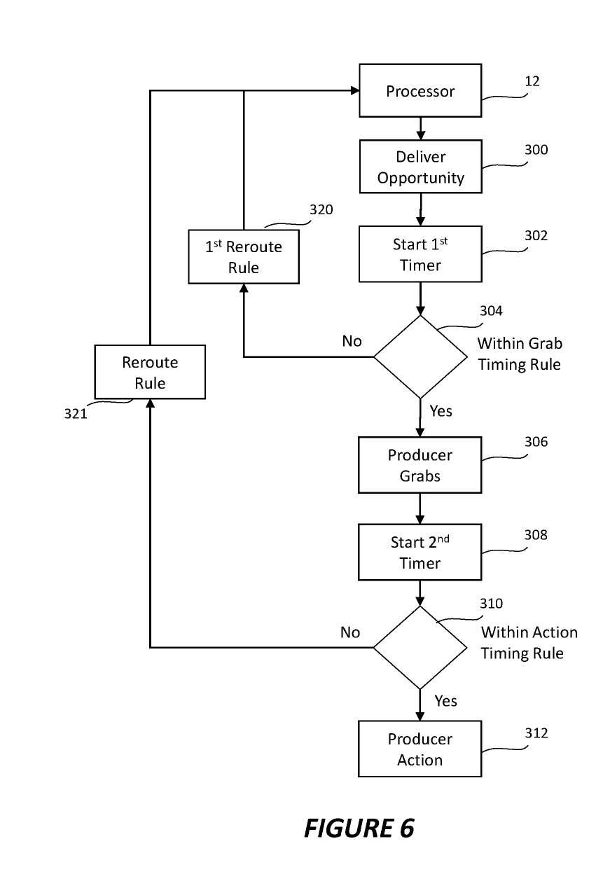

According to the present invention, a flow diagram is shown in FIG. 6 and describes a method for rerouting both an “ungrabbed” and “grabbed” opportunity based upon a producer or agency meeting, or not meeting, a timing rule. As previously described, processor 12 creates opportunity 280 and completes a deliver opportunity step 300. Deliver opportunity step 300 is to a first set of agencies or producers in any of the fashions described in FIGS. 10-13. A first timer 302 is started which measures the time that opportunity 280 has spent in the “ungrabbed” state, and is created from the difference of the current time and createDateTime field 281 of the opportunity, or the Create Date of the prospect record if it is available. If first timer 302 exceeds a grab timing rule 304, system 10 removes opportunity 280 from user interface 100 of the producers and applies a reroute rule 320 to enable to processor 12 to perform delivery opportunity step 300 again, which routes opportunity 280 to a second set of agencies or producers. First timer 302 is restarted and again grab timing rule 304 is applied. Grab timing rule 304 provides the means to motivate producers and agencies from letting new opportunities sit without being “grabbed”. Timing rules 304 and 302 are included in logic

When a producer intends to work or “grab” an opportunity on their user interface 100, they click on a grab link 620 which may be a button on a screen, a link in a text message or such. Grab link 620 sends data 400 back to system 10. A producer grab step 306 starts a second timer 308. An action timing rule 310 measures the time prior to a producer action step 312. If action step 312 is not done quick enough, which may be the difference of the current time and grabDateTime field 282, action timing rule 310 removes opportunity 280 from the producer and applies a second reroute rule 321 for processor 12 to deliver opportunity 280 to another set of agencies or producers. Alternatively, action timing rule 321 may be envoked when the difference between the current time and createDateTime field 281 of opportunity 280 exceeds a certain level, giving producers more incentive to grab an opportunity early. Action timing rule 310 provides the means to motivate producers that grab a lead to take action (phone, email, SMS) immediately.

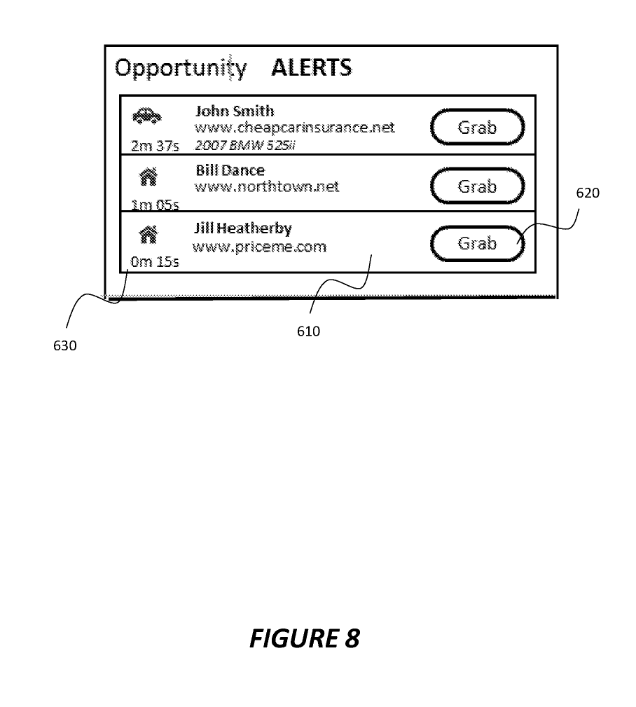

FIGS. 7-9 show an example implementation of the present invention. Although the present invention should not be limited to the images shown or to a particular type of user interface 100, a user screen 600 is part of the best mode of the present invention. User screen 600 provides information to a producer to conduct their normal business, which may include completing scheduled activities and tasks to turn opportunities into sales. A new opportunity alert 610 appears on screen 600 when system 10 routes new opportunity 280 to the producer. One or more of opportunity alert 610 may be visible at any given time. FIG. 8 shows three of opportunity alert 610. Within opportunity alert 610 is a first timer message 630 which is driven by first timer 302. First timer message 630 may either count up until grab timing rule 304 is engaged, or countdown to show how much time is left prior to grab timing rule 304 being engaged. If the producer does not grab a new opportunity in time, the new opportunity is removed from screen 600 of the producers and rerouted based upon first reroute rule 320. If a producer “grabs” the opportunity in time, the preferred embodiment provides information to the user as part of a new opportunity screen 700. A second timing message 720 is shown, similar to first timing message 630, which can either count up or countdown to indicate how long the producer has taken, or has left, prior to engaging action timing rule 310. If the producer does not create action on the new opportunity in time, the new opportunity is removed from screens 600 and 700 of the producer and rerouted based upon second reroute rule 321. An action button 710 is pressed by the user to connect with prospect 99, preferably by phone. Action button 710 may automatically engage a phone system or send an e-mail or text.

The present invention provides the means to ensure that sales people in a distributed agency sales model promptly take action on time sensitive new sales opportunities.

While the agency based new sales opportunity system herein described constitute preferred embodiments of the invention, it is to be understood that the invention is not limited to these precise form of assemblies, and that changes may be made therein with out departing from the scope and spirit of the invention.

I claim:

1. A computer-implemented method of managing leads, comprising:
a processor receiving an amount of prospect data from a source containing information about a sales prospect;
said processor comparing said amount of prospect data to a database of contacts and creating a sales opportunity having a create date for delivery to one or more first producers;
said processor sending an amount of content containing said sales opportunity to said one or more first producers and starting a first timer; and,
said processor applying an amount of logic for rerouting said sales opportunity to a second set of producers if said first timer exceeds a predetermined value prior to said first one or more producers grabbing said sales opportunity.

2. The method of claim 1, wherein sending said amount of content is delivered to a producer user interface for creating an opportunity alert.

3. The method of claim 1, wherein said sending said amount of content creates a first timing message which is visible to said one or more producers.

4. The method of claim 1, wherein said sending amount of content is determined by said processor identifying available agencies of a carrier group record and available producers of a producer group record.

5. The method of claim 1, wherein the step of rerouting includes removing said content from said first one or more producers.

6. A computer-implemented method of managing leads, comprising:
a software system having a processor receive an amount of prospect data from a source containing information about a sales prospect;
said software system comparing said amount of prospect data to a database of contacts and creating a sales opportunity having a create date for delivery to one or more first producers;
said software system sending an amount of content containing said sales opportunity to said one or more first producers and starting a first timer;
a single producer within said one or more first producers grabbing said sales opportunity by sending an amount of response data back to said software system prior to said first timer exceeding a first predetermined value;
said software system starting a second timer after receiving said response data; and,
said processor applying an amount of logic for rerouting said sales opportunity to a second set of producers if said second timer exceeds a predetermined value prior to said single producer creating an action to contact said prospect.

7. The method of claim 6, wherein sending said amount of content is delivered to a producer user interface for creating an opportunity alert having a grab link.

8. The method of claim 6, wherein said sending said amount of content creates a first timing message which is visible to said one or more producers.

9. The method of claim 6, wherein said sending amount of content is determined by said processor identifying available agencies of a carrier group record and available producers of a producer group record.

10. The method of claim 6, wherein said second timer creates a second timing message on a new opportunity screen.

11. The method of claim 6, wherein the step of rerouting includes removing said content from said first one or more producers.

12. A computer-implemented method of managing leads, comprising:
a software system having a processor receive an amount of prospect data from a source containing information about a sales prospect;
said software system comparing said amount of prospect data to a database of contacts and creating a sales opportunity having a create date for delivery to one or more first agencies;
said software system sending an amount of content containing said sales opportunity to said one or more first agencies and starting a first timer;
a producer within said one or more first agencies grabbing said sales opportunity by sending an amount of response data back to said software system prior to said first timer exceeding a first predetermined value;
said software system starting a second timer after receiving said response data; and,
said processor applying an amount of logic for rerouting said sales opportunity to a second set of agencies if said second timer exceeds a second predetermined value prior to said producer creating an action to contact said prospect.

13. The method of claim 12, wherein sending said amount of content is delivered to a producer user interface for creating an opportunity alert.

14. The method of claim 12, wherein the said producer grabs said opportunity by clicking a grab link.

15. The method of claim 12, wherein said sending said amount of content creates a first timing message which is visible to a plurality of sellers within said one or more first agencies.

16. The method of claim 12, wherein said sending amount of content is determined by said processor identifying available agencies of a carrier group record and available producers of a producer group record.

17. The method of claim 12, wherein said second timer creates a second timing message on a new opportunity screen.

18. The method of claim 12, wherein said producer contacts said prospect by engaging with an action button on a new opportunity screen.

19. The method of claim 12, wherein an amount of data about said sales opportunity is sent to one or more carriers.
